(19) United States
(12) Patent Application Publication
(10) Pub. No.: US 2013/0014326 A1
(43) Pub. Date: Jan. 17, 2013

(54) DIVIDED LINENS

(71) Applicants: Shawn Kane, Syracuse, UT (US); Jodie Kane, Syracuse, UT (US)

(72) Inventors: Shawn Kane, Syracuse, UT (US); Jodie Kane, Syracuse, UT (US)

(73) Assignee: COVERHOGS, L.L.C., Syracuse, UT (US)

(21) Appl. No.: 13/546,113

(22) Filed: Jul. 11, 2012

Related U.S. Application Data
(60) Provisional application No. 61/506,605, filed on Jul. 11, 2011.

(51) Int. Cl. A47G 9/02; B23P 17/04; B32B 37/12

(52) U.S. Cl. 5/482; 156/227; 493/356

(57) ABSTRACT

The present invention discloses divided linens, such as sheets and blankets, which are partially divided for use by more than one person. The divided linens comprise a pair of linen panels joined at a bottom end to form an integral unit, and optionally detachably joined at the head end.

### RELATED APPLICATIONS

The present application claims the benefit of U.S. Provisional Patent Application Ser. No. 61/506,605, filed Jul. 11, 2011, which is incorporated herein by reference in its entirety.

### BACKGROUND OF THE INVENTION

1. The Field of the Invention

The present invention is related to bedding, and more particularly to divided linens such as sheets and blankets which are partially divided for use by more than one person.

2. State of the Art

When linens such as sheets and blankets are shared by more than one person, such as on a queen size or king size bed, they are often pulled to one side or bunched in the middle, leaving one or both people partially or fully uncovered. This can occur when a restless sleeper rolls over or pulls on blankets during the night or when one goes to bed after the other.

Another problem commonly experienced by people sharing blankets is that one person may prefer warmer blankets than the other, leading to compromises that do not fully suit one or both sleepers.

### SUMMARY OF THE INVENTION

The present invention may include divided linens such as sheets and blankets which are partially divided for use by more than one person.

In accordance with one aspect of the invention, divided linens may include a pair of linen panels, joined at a bottom end to form an integral unit. The linen panels may be usable to independently cover different sections of a bed, providing a pair of users with their own bed covering, independent of the other's, and yet joined at the bottom end to provide the appearance and utility of a single bed covering.

In accordance with another aspect of the invention, the divided linens may include linen panels which may be detachably joined or connected using temporary attachments such as Velcro, buttons, snaps, fabric or cord ties, magnets, zippers, etc. The linen panels may comprise the same material, or may have different fabrics, thicknesses, weights, styles and colors, etc, providing customization for different users. The divided linens may be made using one, two, three or more fabric panels.

In accordance with another aspect of the invention, the divided linens may include divided flat sheets, divided blankets, or a combination of divided sheets and blankets, sewn or otherwise joined together as an integral unit.

It will be appreciated that the preceding is merely a summary of some aspects of the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals may be used throughout several drawings to refer to similar components.

FIG. 1 depicts a perspective end view of a bed with divided sheets and blankets in accordance with some aspects of the present invention;

FIG. 2 depicts a side view of an example of a bed on which various embodiments of divided linens may be used;

FIG. 3 depicts an end view of an example of a bed on which various embodiments of divided linens may be used;

FIG. 4 depicts a top view of a two-panel divided bed covering with a left portion (in solid lines) overlapping a right portion (in divided lines) in accordance with some embodiments of the present invention;

FIG. 5 depicts a top view of queen sized divided linens with the panels joined at a bottom end in accordance with some embodiments of the present invention;

FIG. 6 depicts a top view of king sized divided linens in accordance with some embodiments of the present invention;

FIG. 7 depicts a top view of divided linens with panels higher than the embodiment of FIG. 5 in accordance with some embodiments of the present invention;

FIG. 8 depicts a top view of divided linens with a detachable connection strip between two panels in accordance with some embodiments of the present invention;

FIG. 9 depicts a top view of divided linens with multiple detachable connection strips between two panels in accordance with some embodiments of the present invention;

FIG. 10 depicts a top view of divided linens with multiple connection points between two panels in accordance with some embodiments of the present invention; and

FIGS. 11-14 depict steps in manufacturing divided linens from a single piece of fabric in accordance with some embodiments of the present invention, wherein:

FIG. 11 depicts a top view of a single piece of fabric with cut lines designated by single solid lines and fold lines designated by double solid lines;

FIG. 12 depicts an end view of the single piece of fabric of FIG. 11 as it is folded along the fold lines of FIG. 11;

FIG. 13 depicts a top view of the folded piece of fabric of FIG. 11 with cut edges designated by single solid lines and with folded edges designated by double lines, with covered edges designated by dashed lines;

FIG. 14 depicts a top view of the folded piece of fabric of FIG. 13 with seams or other attachments designated by zigzag lines; and

FIG. 15 depicts a top view of queen sized divided linens with the panels joined at a bottom end and with a slit enabling one panel of the divided linens to be sandwiched between panels of another set of divided linens in accordance with some embodiments of the present invention.

It will be appreciated that the drawings are illustrative and not limiting of the scope of the invention which is defined by the appended claims. The embodiments and configurations shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

The drawings and description, in general, disclose various embodiments of divided linens or bed coverings such as sheets and blankets which are partially divided for use by more than one person. Some embodiments of divided linens include a pair of linen panels, joined at a bottom end to form an integral unit. The linen panels are usable to independently cover different sections of a bed, providing a pair of users with their own bed covering, partially independent of the other's, and yet joined at the bottom end to provide the appearance and utility of a single bed covering. In some embodiments, the linen panels may be detachably joined or connected using temporary attachments such as Velcro, buttons, snaps, fabric or cord ties, magnets, zippers, etc. The linen panels may comprise the same material, or may have different fabrics, thicknesses, weights, styles and colors, etc, providing customization for different users. The divided linens may be made using one, two, three or more fabric panels. Various embodiments of the divided linens may include divided flat sheets, divided blankets, or a combination of divided sheets and blankets, sewn or otherwise joined together as an integral unit.

The terms “linens” and “bed coverings” are used synonymously herein to describe sheets and/or blankets in any variation. The term “sheets” is used generally herein to refer to coverings, typically but not necessarily fabric, for use by individuals when sleeping. While the term “sheets” may apply to either fitted sheets for use under sleeping individuals or flat or top sheets for use over sleeping individuals, in many embodiments described herein the term “sheets” is used specifically to refer to flat or top sheets. The term “blanket” is used generally herein to refer to a covering, typically but not necessarily fabric, for use by individuals when sleeping, typically thicker than sheets and used primarily for warmth. Non-limiting examples of blankets include quilts, comforters, duvets and duvet covers, electric blankets, etc.

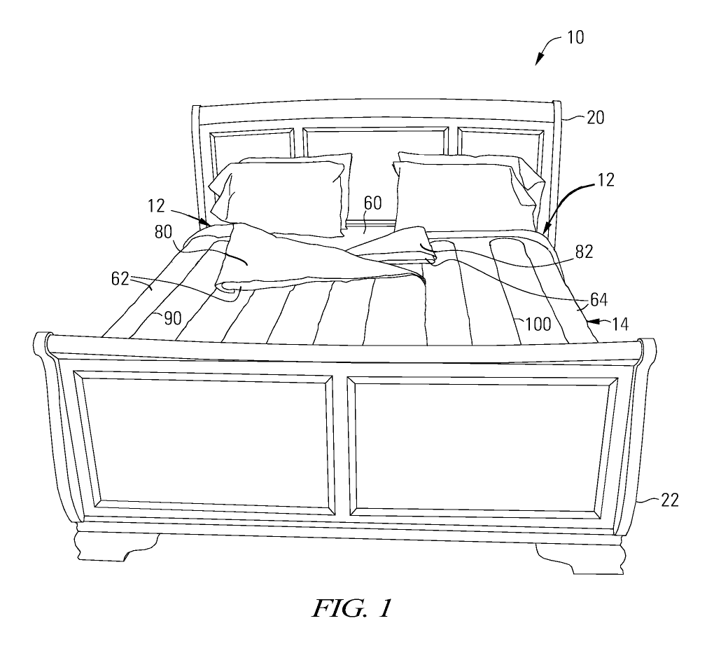

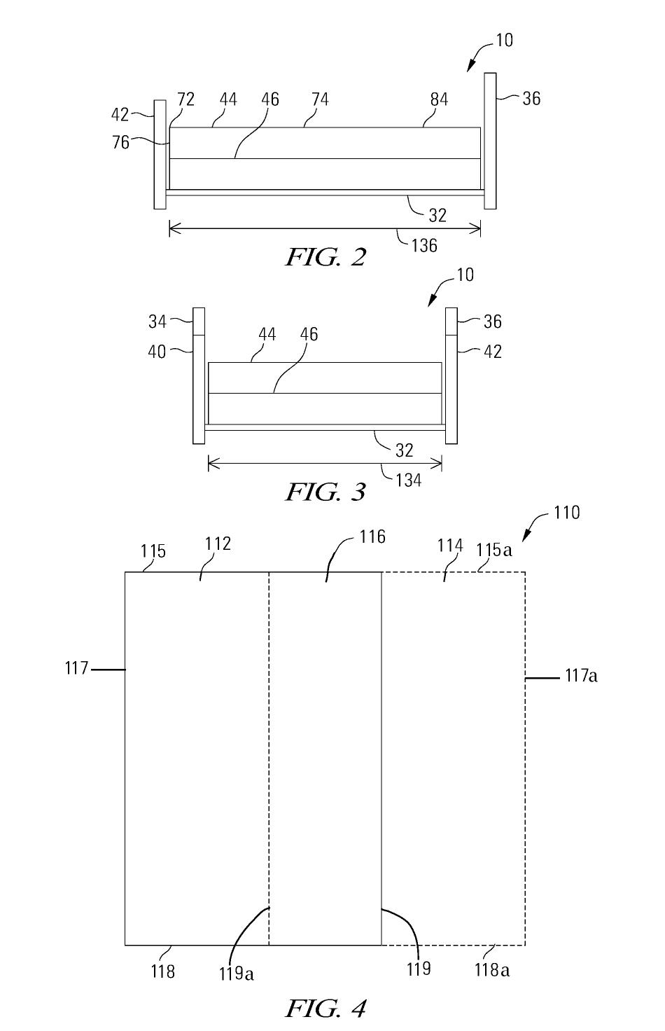

Referring now to FIG. 1, an example of a bed 10 is illustrated with both divided sheet 12 and divided blanket 14. The divided linens (e.g., 12 and 14) disclosed herein may be adapted for use on any type of bed, with or without mattresses, with or without headboard 20, footboard 22, and other bed structures now known or which may be developed in the future. For example, divided linens (e.g., 12 and 14) may be used on a bed 10 such as that illustrated in FIGS. 2 and 3 having a frame 32, head posts 34 and 36 and foot posts 40 and 42, or with other types of bed such as waterbeds, futons, captain's bed, etc., or indeed without a bed frame. Divided linens (e.g., 12 and 14) may also be used with any type of mattress, including the inner spring coil mattress 44 and box spring 46 illustrated in FIGS. 2 and 3, other types of mattress such as foam, air, latex, natural fiber mattresses such as futon mattresses, etc., or indeed without a mattress. (Bed 10 is illustrated in FIGS. 2 and 3 without linens to illustrate an example of one use for divided linens.)

Referring again to FIG. 1, example bed 10 is made up with pillows and a fitted sheet 60, divided sheet 12 and divided blanket 14. Divided blanket 14 includes a first panel 62 and a second panel 64, adapted to independently cover two individuals. Inner top corners of each panel are turned back in FIG. 1 to more clearly show the different panels in the divided sheet 12 and divided blanket 14 and to illustrate one possible aesthetically pleasing manner of making the bed 10 with divided linens (e.g., 12 and 14). The first panel 62 and second panel 64 of the divided blanket 14 are joined in some embodiments along a bottom portion (hidden in FIG. 1 by footboard 22), for example by a seam positioned in some embodiments at about the foot edge 72 of the bed 10 between the top 74 (see FIG. 2) and the foot end 76 of the bed 10. Divided sheet 12 is also provided, in the embodiment of FIG. 1, with a first panel 80 and a second panel 82, joined along a bottom portion as with divided blanket 14, but adapted to independently cover two individuals. In some embodiments, the divided sheet 12 is longer at the head 84 (see FIG. 2) of the bed 10, allowing the top of the divided sheet 12 to be folded over the top of the divided blanket 14 as illustrated in FIG. 1. This keeps the top of the divided blanket 14 cleaner and may be more comfortable and aesthetically pleasing to some individuals.

The divided sheet 12 and divided blanket 14 may be made of any suitable fabric or other material, in any desired color, pattern, texture, etc. For example, the divided blanket 14 of FIG. 1 is quilted along quilting seams 90 and 100, providing a pleasing design while holding interior batting in place. The individual panels 62 and 64 of the divided blanket 14 may be made of different materials, for example increasing the warmth for one individual or providing different textures. When different materials are used, they may have different appearances or similar or identical appearances to maintain a harmonious overall appearance.

Turning now to FIG. 4, divided linens 110 may be manufactured in some embodiments from two panels 112 and 114, each having a head edge 115 and 115a, bottom edge 118 and 118a, outside edge 117 and 117a, and inside edge 119 and 119a, respectively. The panels overlap along a center portion 116. (The first panel 112 is shown with solid line, the second panel 114 is shown with dashed line, with the second panel 114 partially underneath the first panel 112.) This overlap facilitates the use of the divided linens 110 as an integral unit, shared by two individuals without a gap in coverage between them unless they want to pull the panels 112 and 114 more closely around themselves.

As illustrated in FIG. 5, the panels 112 and 114 are joined in some embodiments to form an integral unit, for example by a seam 120 in a region of overlap between the inside edges 119 and 119a to create a joined portion 132. The seam 120 is shown with a zigzag line to distinguish from other lines in the figures. However, the panels 112 and 114 are not limited to any particular type of connection or attachment, and the zigzag line is not intended to specify or illustrate the type of connection or seam. The seam 120 in some embodiments is formed by sewing the panels 112 and 114 together, for example using a quarter inch reinforced double stitch. In other embodiments, other connection types may be used, such as adhesives, thermal fusing, mechanical fasteners such as plastic rivets or zippers, or even detachable connectors such as hook and loop (VELCRO®), snaps, buttons, fabric ties, etc. The seam 120 may be positioned along the inside and bottom edges 122, 124 and 126 of the joined portion where the panels 112 and 114 overlap, and along a line 130 corresponding about to the foot edge of a bed, so that the resulting divided linens 110 are joined along the foot end of the bed but are independent on the top of the bed. The seam 120 may also be continued or positioned anywhere in the joined portion 132 between the panels 112 and 114. In one aspect of the invention, for example as shown in FIG. 5, the first and second panels 112 and 114 are unslitted, meaning that there are no slits in the panels 112 and 114 extending from an inside edge 119 or 119a toward an outside edge 117 or 117a. In another aspect, as depicted in FIG. 15, a panel may have a slit 300.

Although the divided linens 110 are not limited to any particular dimensions, the example divided linens 110 of FIG. 5 are adapted for use with a conventional queen size mattress of 60 inches across a lateral dimension 134 from side to side (see FIG. 3) and 80 inches across a longitudinal dimension 136 from foot 72 to head 84. Although the dimensions of divided linens 110 may vary even for use with a particular size mattress 44, in one embodiment the panels 112 and 114 may have a length 140 of 96 inches, widths 142 and 144 of 66 inches, with an overlap 146 of 29 inches, for an overall width 150 of 103 inches. The top line 130 of seam 120 in this example may be placed at a distance 152 of 20 inches from the bottom 154 of the divided linens 110. In some embodiments, the panels 112 and 114 have the size of standard US twin sheets, at 72 inches by 102 inches, both in the queen and king size divided linens 110, with the overlap 146 being adjusted to form either queen or king size divided linens 110. The dimensions set forth here may be for use either with divided sheets or blankets, although as discussed above, the length 140 may be greater by several inches for divided sheets than for divided blankets, allowing the two to be used together with the sheets overlapping the top edge of the blankets if desired. The degree of overlap between panels is also not limited to the dimensions set forth in the examples discussed herein, but may be adapted as desired, either providing additional coverage for sleepers or minimizing material usage.

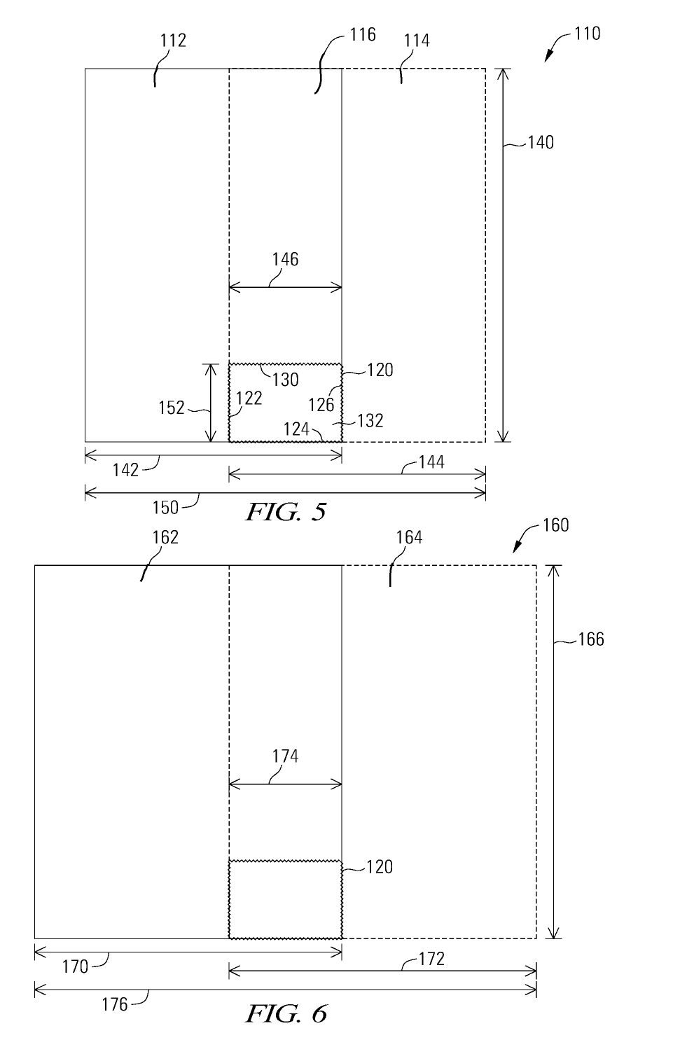

An example of divided linens 160 adapted for use with a conventional king size mattress of 76 inches across lateral dimension 134 and 80 inches across longitudinal dimension 136 is illustrated in FIG. 6. In this example embodiment, panels 162 and 164 have a length 166 of 96 inches, widths 170 and 172 of 79 inches, with an overlap 174 of 29 inches, for an overall width 176 of 129 inches. The seam 120 in this embodiment is positioned as in the divided linens 110 of FIG. 5, although it is not limited to this arrangement.

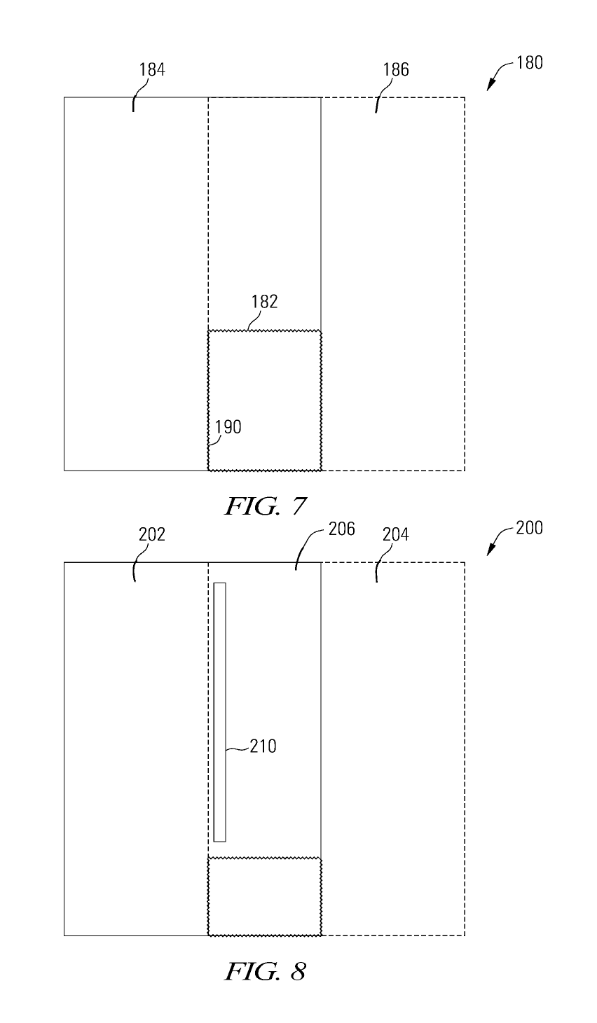

Turning now to FIG. 7, an embodiment of divided linens 180 is illustrated in which the top line of seam 182 is positioned higher up on the divided linens 180 than in previous embodiments, above the foot edge of a bed. In this embodiment, the panels 184 and 186 will not be separable along the full length of the top of the bed, which in some cases may make it easier for users' feet to wander across the bed without catching in the edge 190 of the second panel 186.

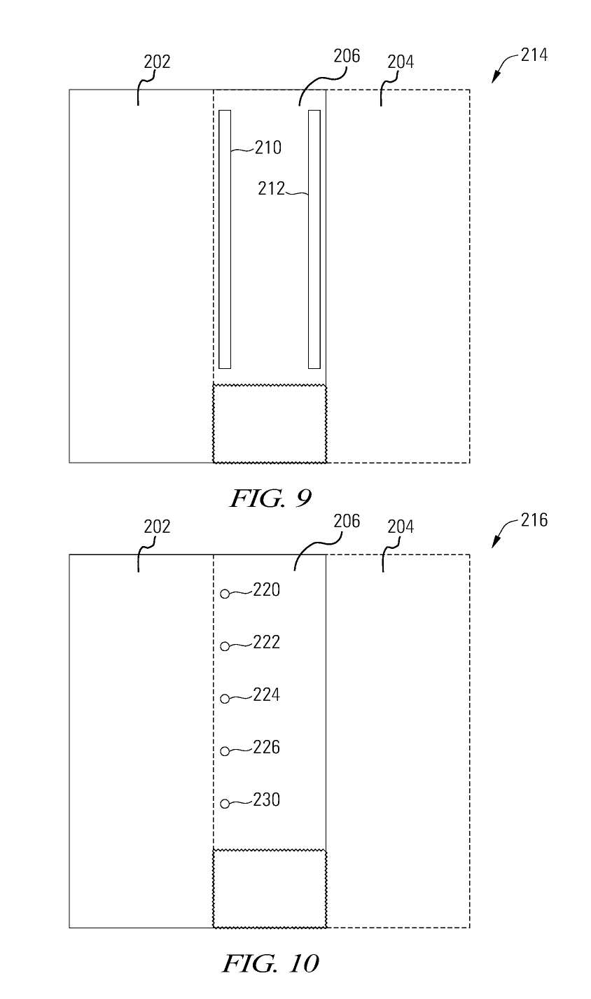

In some embodiments, the panels are adapted to be detachably connected to each other on top of the bed, as illustrated in FIG. 8. For example, divided linens 200 have a first panel 202 and a second panel 204 with an overlapping center portion 206 between them. A detachable connector 210 is provided along a strip in the overlapping center portion 206 between the panels 202 and 204. When connected, the detachable connector 210 enables the divided linens 200 to be treated as a single integral unit, both when making the bed and when sleeping. When the users prefer separate bed coverings, the detachable connector 210 can be undone, separating the panels 202 and 204. The detachable connector 210 may comprise any suitable type of fastening that may be disconnected, whether now known or that may be developed in the future. For example, the detachable connector 210 may be a zipper or a hook and look fastener (i.e. VELCRO®) strip with a hook strip sewn to one panel (e.g., 202) and a loop strip sewn to the other panel (e.g., 204). Multiple detachable connector strips 210 and 212 may be provided in some divided linens 214, as illustrated in FIG. 9, connecting several edges in the overlapping center portion 206. In other divided linens 216 as illustrated in FIG. 10, multiple detachable connectors 220, 222, 224, 226 and 230 may be provided in any location in the overlapping center portion 206. Examples of detachable connectors that may be used with divided linens include Velcro, snaps, zippers, buttons and toggles, fabric or cord ties, magnets embedded within the material, and the like.

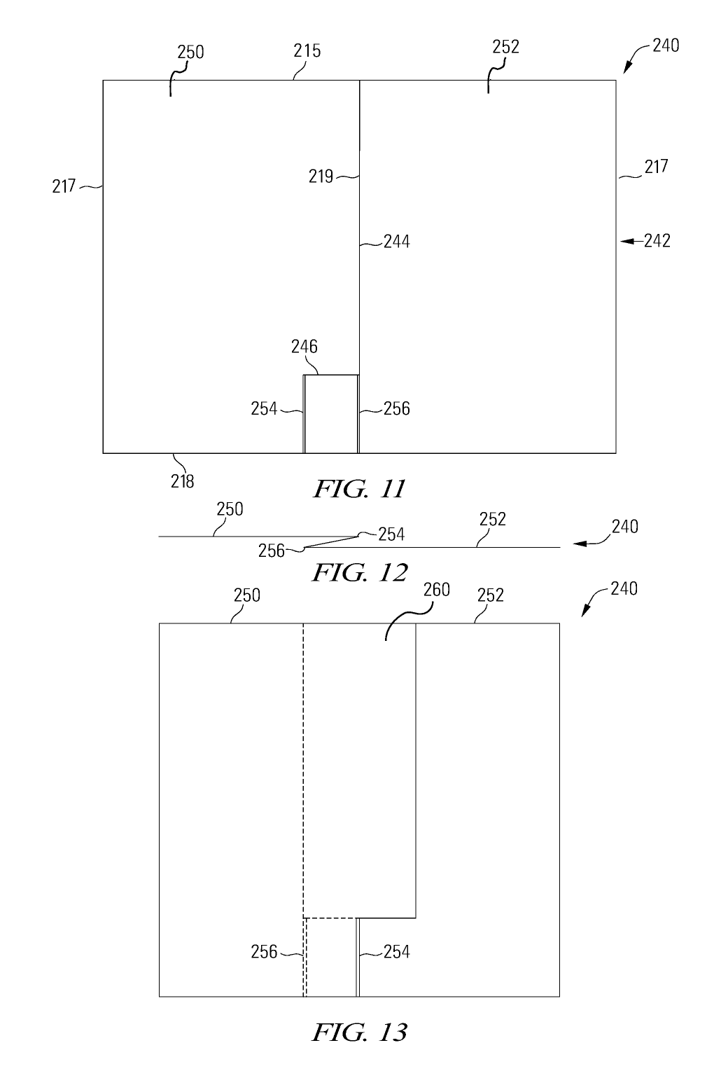

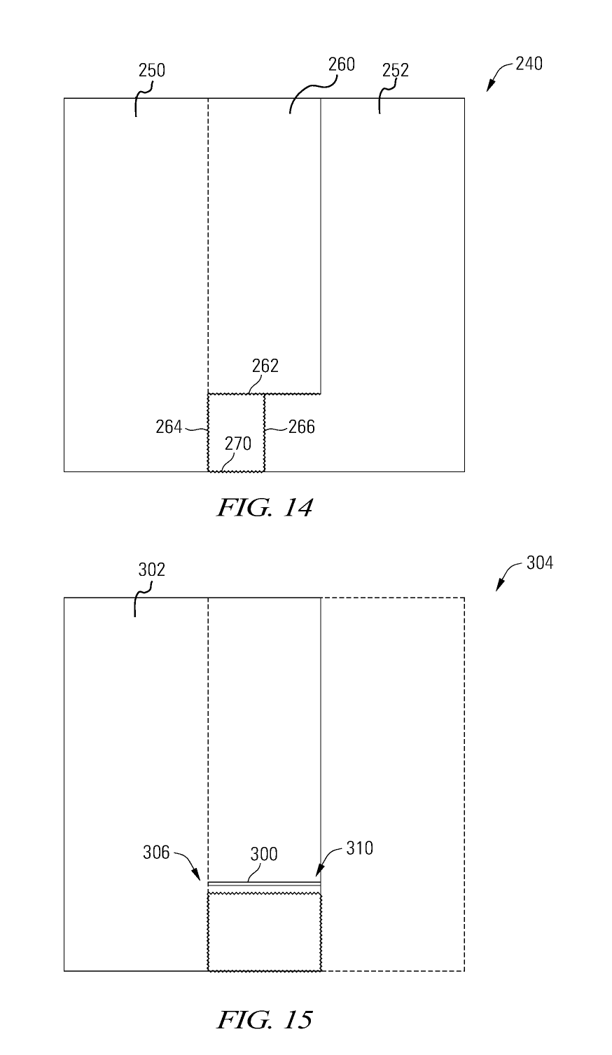

Divided linens may be fabricated using two or more pieces of fabric or other material, as shown in the examples above, or using a single piece of fabric, folded and sewn as illustrated in FIGS. 11-14. For example, divided linens 240 may be formed using a single piece of fabric 242, cutting a slit 244 from the head edge 215 toward the bottom edge 218 and terminating at a point above the bottom edge, preferably at a point corresponding to a foot edge of a bed, to form panels 250 and 252 (FIG. 11). A slit 246 is then cut from the end of slit 244 toward outside edge 217 of the first panel 250, generally perpendicular to slit 244 and parallel to the bottom edge 218. The first panel is then folded along fold axis 254 and fold axis 256 in a ‘Z’ shape as illustrated in FIG. 12 to create an overlapping center portion 260 (FIG. 13). Seams 262, 264, 266 and 270 (FIG. 14) may be formed by any type of fastening or joining mechanism to hold the divided linens 240 as folded, forming an integral unit with separable but overlapping panels 250 and 252. Again, the divided linens are not limited to the example configurations and manufacturing processes described herein, but may be varied and adapted in a wide range of manners without departing from the inventive concepts disclosed herein.

Another embodiment, shown in FIGS. 1 and 15, allows divided linens to be used in conjunction with divided blankets. Referring to FIG. 1, the first panel 80 of divided sheets is sandwiched between the two panels 62 and 64 of a set of divided blankets 14 placed over the divided sheets 12. Because the first panel 62 of the divided blankets overlaps the second panel 64 of the divided blankets, the divided sheets 12 may be configured so that the first panel 80 of the divided sheets overlaps the second panel 64 of the divided blankets. To accomplish this, as shown in FIG. 15, a slit 300 may be cut in a first panel 302 of a set of divided sheets 304. The second panel of divided blankets (not shown) can be inserted into the slit so that the second panel of the divided blankets is below the first panel 302 of the divided linens 304. A region 306 at the end of the slit 300 may be reinforced to prevent tearing. The slit 300 enables the first panel 302 of the divided linens 304 to be inserted between the first and second panels of divided blankets, as shown in FIG. 1, in which the first panel 80 of divided sheet 12 lies between the first panel 62 and second panel 64 of divided blanket 14. In this way, the first panel of the divided sheets 304 can remain immediately underneath only the first panel of the divided blankets, and the second panel of the divided sheets 304 can remain immediately underneath only the second panel of the divided blankets. Fasteners may be provided to close the slit 300 when desired, for example using a zipper along the slit 300, thus providing an unslitted panel. Fasteners may also be provided to connect the panel 302 to either or both the panels of a divided blanket when the panel 302 is sandwiched between the panels of the divided blanket. For example, a hook and loop patch or other type of fastener may be provided at an outer corner 310 above the slit 300, with a corresponding fastener in either or both the panels of a divided blanket. In other embodiments, the first panel of a set of divided sheets may be folded to lie between the first and second panels of a divided blanket without a slit 300.

The divided linens disclosed herein enable sleepers to share a bed and bed coverings without disturbing or being disturbed by their partner as they get in and out of bed, roll or move about in bed. Each sleeper has independent sheets and/or blankets when desired, without losing the benefits of a single integral bed covering that can be made up easily and in an aesthetically pleasing way. Panels in divided linens may be detachably connected when desired, enabling sleepers to treat the divided linens as a single traditional bed covering, for example allowing them to cuddle in the middle of the bed without becoming entangled or uncovered, then allowing them to separate the panels for individual use when desired. Each sleeper may be provided with bed coverings having their desired warmth by customizing the thickness or material in each panel of the divided linens. These and other benefits are provided, simply and inexpensively, by the divided linens disclosed herein.

In conclusion, the present invention provides novel systems, devices, methods and arrangements for divided linens. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A bed covering, comprising:
a first panel of material and a second panel of material each having a head edge, a bottom edge, an inside edge, and an outside edge;
an overlapping center portion wherein a portion of the first panel overlaps a portion of the second panel along the lengths of the corresponding inside edges of both panels; and
a joined portion wherein portions of the first and second panels within the overlapping center portion are joined together.

2. The bed covering of claim 1, wherein the first panel of material is unslitted and the second panel of material is unslitted.

3. The bed covering of claim 1, wherein the joined portion is permanently joined.

4. The bed covering of claim 3, wherein the joined portion is joined by a seam, adhesive, thermal fusing, or plastic rivets.

5. The bed covering of claim 1, wherein the joined portion is detachably joined.

6. The bed covering of claim 5, wherein the joined portion is joined by zippers, snaps, hook and loop, buttons, or fabric ties.

7. The bed covering of claim 1, wherein the joined portion comprises a joint along one or more of the following: the overlapping bottom edges, the inside edge of the first panel, the inside edge of the second panel, and transversely across the overlapping center portion between the inside edges at a location above the overlapping bottom edges.

8. The bed covering of claim 7, wherein the first and second panels are adapted to remain independent on top of a bed when used on a bed.

9. The bed covering of claim 1, wherein the first and second panels are substantially rectangular and of equal dimensions, and wherein the overlapping center portion is substantially rectangular.

10. The bed covering of claim 9, wherein the joined portion is substantially rectangular and positioned to remain below the top of a bed when used on a bed.

11. The bed covering of claim 1, wherein the length of the inside edge of the first panel is substantially parallel to the length of the inside edge of the second panel.

12. The bed covering of claim 1, wherein the first panel and the second panel comprise a single piece of material, the first panel has a slit above the joined portion, and the joined portion comprises a portion of the first panel folded under the first panel and above a portion of the second panel.

13. The bed covering of claim 1, further comprising one or more detachable connectors for attaching the first panel to the second panel.

14. The bed covering of claim 1, wherein the first panel and second panel comprise different types of material adapted to provide differing degrees of warmth, textures, designs, or patterns.

15. Divided linens, comprising divided sheets forming a bed covering in accordance with claim 1 and divided blankets forming a bed covering in accordance with claim 1, wherein:
the first panel of the divided sheets comprises a slit above the joined portion;
the first panel of the divided blankets is disposed on top of the first panel of the divided sheets;
the second panel of the divided blankets is disposed on top of the second panel of the divided sheets; and
the second panel of the divided blankets is disposed on top of the joined portion of the divided sheets below the slit and below the first panel of the divided sheets above the slit.

16. The divided linens of claim 15, wherein the slit is adapted to be closed by a fastener.

17. A method of making a divided bed covering, comprising:
forming a first panel and a second panel from a single piece of material having a head edge, bottom edge, and opposing outside edges by cutting a first slit from the head edge toward the bottom edge in a substantially straight line parallel to a side edge and terminating the first slit at a point above the bottom edge;
cutting in the first panel a second slit from the end of the first slit toward the outside edge in the first panel in a substantially straight line perpendicular to the first slit and terminating at a point before the outside edge;
folding the first panel over the second panel along a first fold axis extending from the end of first slit to the bottom edge;
folding the first panel over itself along a second fold axis extending from the end of the second slit toward the bottom edge in a straight line substantially parallel to the first fold axis; and
joining the first panel and second panel.

18. The method of claim 17, wherein said step of joining comprises joining the first and second panels along one or more of: the first fold axis, the second fold axis, the bottom edge, and the second slit.

19. The method of claim 18, wherein said joining comprises one or more of a seam, adhesive, thermal fusing, plastic rivet, zipper, snap, hook and loop, button, or fabric tie.

20. The method of claim 17, wherein said first slit and second slit are adapted to dispose the joined portion below the foot edge of a bed.
